(19) United States
(12) Patent Application Publication
(10) Pub. No.: US 2021/0239194 A1
(43) Pub. Date: Aug. 5, 2021

(54) TENSIONER WITH A BASE HAVING A CAPTURED DAMPING SPRING

(71) Applicant: BorgWarner Inc., Auburn Hills, MI (US)

(72) Inventors: Eric A. PENNIMAN, Cortland, NY (US); Neal KERWIN, Freeville, NY (US)

(21) Appl. No.: 16/782,433

(22) Filed: Feb. 5, 2020

(51) Int. Cl. F16H 7/12

(52) U.S. Cl. CPC F16H 7/1281; F16H 2007/0865

(57) ABSTRACT

A tensioner having a head, a shaft, a spring, a first arm, and a first tensioner wheel. The shaft has a spring mount and is fixedly coupled to the head. The spring mount is disposed axially adjacent to the head and has an exterior surface that is smaller in diameter than an exterior surface of an adjacent portion of the shaft. The spring is received on the spring mount and is captured between the adjacent portion of the shaft and the head. The first arm is disposed on the shaft for pivoting motion about a pivot axis. The first tensioner wheel is coupled to the first arm for rotation about a first tensioner wheel axis that is parallel to but spaced apart from the pivot axis. The spring exerts an axial force that is directed along the pivot axis to urge the first arm away from the head.

### FIELD

The present disclosure relates to a tensioner with a base having a captured damping spring.

### BACKGROUND

This section provides background information related to the present disclosure which is not necessarily prior art.

Tensioners for drive systems, such as those used for the tensioning of a belt in a front engine accessory drive of a vehicle, can sometimes employ friction forces that are disposed along a pivot axis of an arm of the tensioner to dampen pivoting movement of the arm about the pivot axis. One drawback of such tensioners concerns the assembly of a damping spring onto the base of the tensioner. More specifically, the damping spring is typically loosely installed over a shaft that is part of or coupled to the base. Depending on the orientation of the various components on the tensioner when the damping spring is located onto the shaft during the assembly of the tensioner, it may be not be desirable for the damping spring to be loose during the assembly process.

### SUMMARY

This section provides a general summary of the disclosure, and is not a comprehensive disclosure of its full scope or all of its features.

In one form, the present disclosure provides a tensioner that includes a tensioner that includes a base, a spring, a first arm and a first tensioner wheel. The base defines a pivot axis and has a shaft, and a head. The shaft is fixedly coupled to the head and has a spring mount that is disposed axially adjacent to the head. The spring mount has an exterior surface that is smaller in diameter than an exterior surface of a portion of the shaft that is adjacent to the spring mount. The spring is received on the spring mount. The shaft and the head cooperate to limit movement of the spring in an axial direction along the pivot axis. The first arm is disposed on the shaft for pivoting motion about the pivot axis. The first tensioner wheel is coupled to the first arm for rotation about a first tensioner wheel axis that is parallel to but spaced apart from the pivot axis. The spring exerts an axial force that is directed along the pivot axis to urge the first arm away from the head.

In some embodiments, the spring includes one or more Belleville spring washers.

In some embodiments, the tensioner includes a seal, which is received into a seal groove that is formed about a circumference of the head and which is sealingly engaged to the head. Optionally, the seal can also sealingly engage the first arm.

In some embodiments, the base further defines a coupling segment that is disposed on an end of the shaft opposite the spring mount and the tensioner further includes a closure member that is received onto the coupling segment. Optionally, the closure member is slidably received on the coupling segment and does not engage a hard stop formed on a component of the tensioner that would limit movement of the closure member along the pivot axis in a direction toward the spring. In some forms, the closure member engages the cylindrical surface with an interference fit, such as a press fit.

In some embodiments, the tensioner includes a second arm and a second tensioner wheel. The second arm is disposed on the shaft for pivoting motion about the pivot axis. The second tensioner wheel is coupled to the second arm for rotation about a second tensioner wheel axis that is parallel to but spaced apart from the pivot axis. Optionally, the first arm is disposed along the pivot axis between the spring and the second arm. Also optionally, the tensioner includes a torsion spring that is disposed between the first and second arms. The torsion spring biases the first and second arms toward one another about the pivot axis. In some forms, the tensioner can include a closure member, a first seal and a second seal. The closure member is coupled to the base on a side of the shaft that is opposite the spring mount. The first seal is sealingly engaged to the closure member and the first arm, while the second seal is sealingly engaged to the first and second arms. In some forms, the torsion spring has a plurality of helical coils that are disposed between a first spring end, which abuts the first arm, and a second spring end that abuts the second arm.

In some embodiments, the tensioner includes a torsion spring that is coupled to the first arm and configured to bias the first arm in a predetermined direction about the pivot axis. Optionally, the torsion spring has a plurality of helical coils that are disposed between a first spring end, which abuts the first arm, and a second spring end.

In another form, the present disclosure provides a method for assembling a tensioner. The method includes: providing a shaft, and a head, the shaft having a head mount and a spring mount; positioning a spring over the shaft and onto the spring mount; assembling the shaft to the head such that the head and a shoulder formed on the shaft limit movement of the spring along the pivot axis in a direction away from the head; assembling a first arm onto the shaft; applying an axial preload to the spring; and coupling a closure member to base to maintain the axial preload on the spring.

In some embodiments, the method includes assembling a second arm to the shaft prior to applying an axial preload to the spring. The first arm is disposed along the pivot axis between the spring and the second arm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a tensioner constructed in accordance with the teachings of the present disclosure;

FIG. 2 is a front exploded perspective view of the tensioner of FIG. 1;

FIG. 3 is a rear exploded perspective view of the tensioner of FIG. 1;

FIG. 4 is a section view of a portion of the tensioner of FIG. 1, the view being taken along a pivot axis; and

FIG. 5 is an enlarged portion of FIG. 4.

Corresponding reference numerals indicate corresponding parts throughout the several views of the drawings.

### DETAILED DESCRIPTION

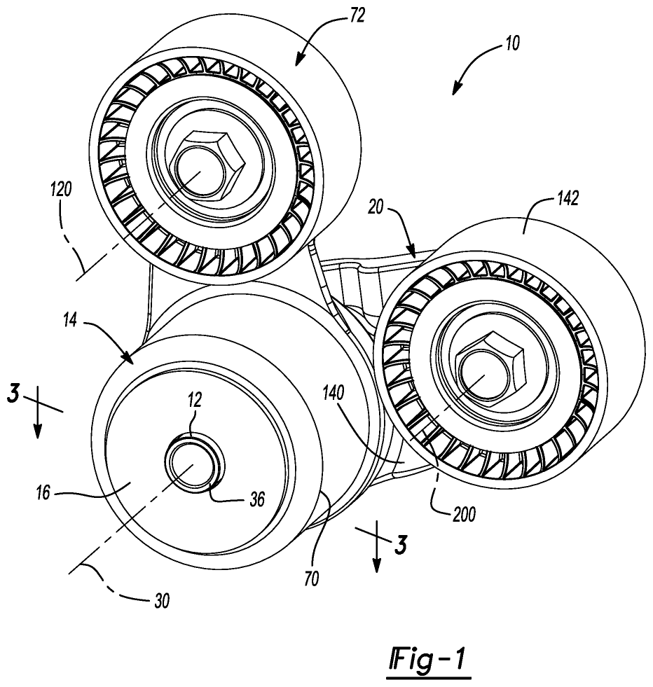

With reference to FIGS. 1 through 3 of the drawings, an exemplary tensioner constructed in accordance with the teachings of the present disclosure is generally indicated by reference numeral 10. The tensioner 10 includes a base 12, a spring 14, and a first arm assembly 16 and may optionally include a second arm assembly 18, a torsion spring 20, a closure member 22 and first, second and third seals 24, 26 and 28, respectively.

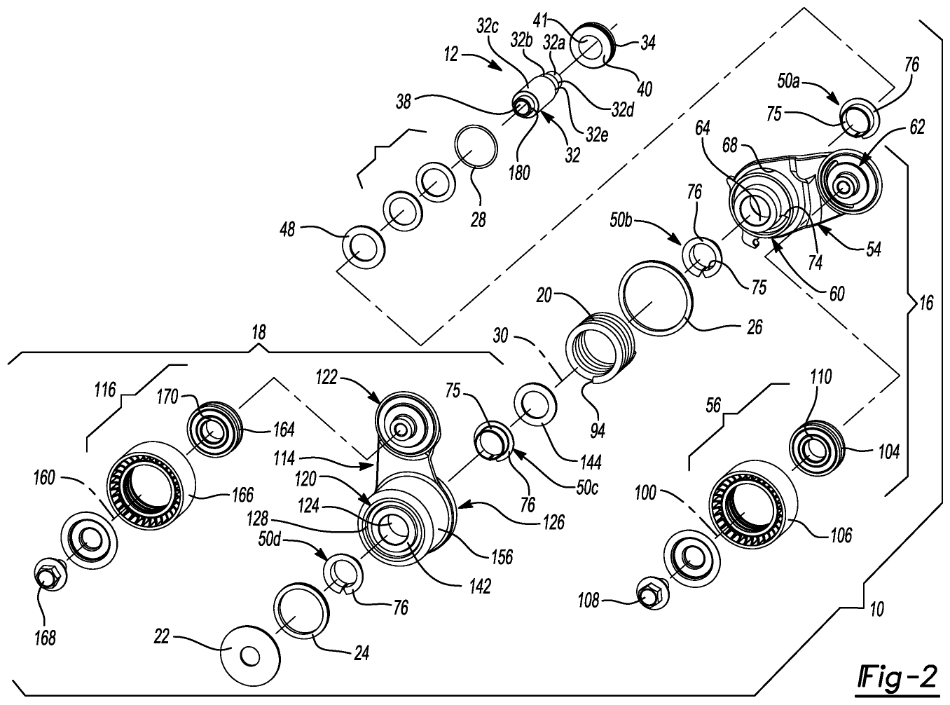

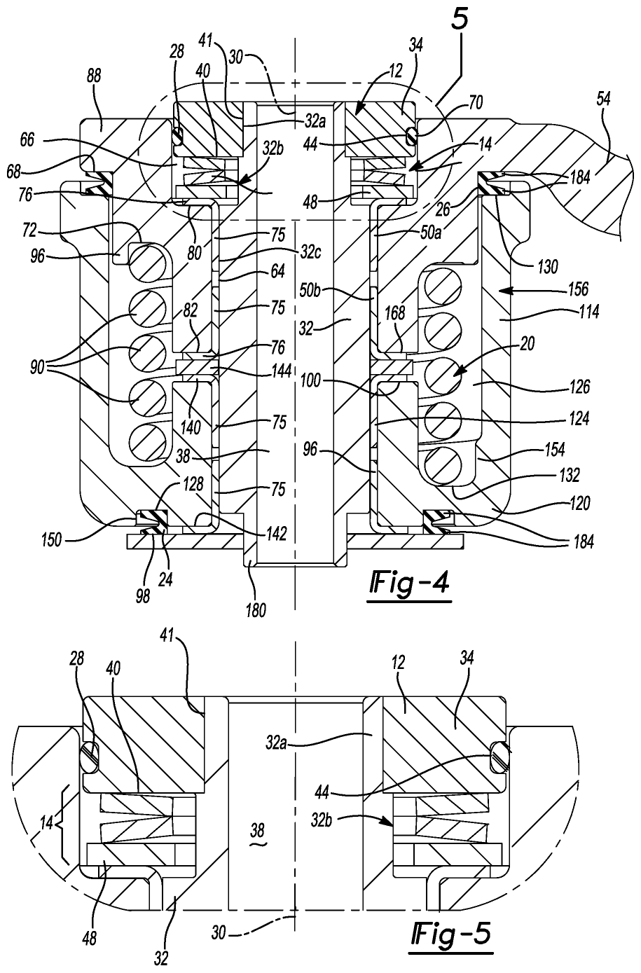

With reference to FIGS. 2 and 4, the base 12 can define a pivot axis 30 and can include a shaft 32, and a head 34. The shaft 32 can include a head mount 32a, a spring mount 32b, and a shaft portion 32c. The head mount 32a can formed with a right cylindrical exterior surface having a first diameter. The spring mount 32b can be formed with a right cylindrical exterior surface having a second diameter that is relatively larger than the first diameter. The shaft portion 32c can be formed with a right cylindrical exterior surface having a third diameter that is larger than the second diameter. Accordingly, it will be appreciated that the shaft 32 also defines a first shoulder 32d where the head mount 32a meets the spring mount 32b, and a second shoulder 32e where the spring mount 32b meets the shaft portion 32c. In the example provided, a through-hole 38 is formed entirely through the shaft 32 and is configured to receive a fastener (not shown) therethrough that permits the base 12 to be fixedly coupled to a desired structure, such as an internal combustion engine (not shown). The head 34 is comparatively larger in diameter than the shaft 32 and defines an axial end face 40 and a through-hole 41. The head 34 can also define a seal groove 44 that is configured to receive the third seal 28. The through-hole 41 in the head 34 is sized to receive the head mount 32a of the shaft 32 in a press-fit manner such that the axial end face 40 abuts the first shoulder 32d.

With reference to FIGS. 2 and 5, the spring 14 is assembled to the shaft 32 prior to the assembly of the head 34 and the shaft 32 such that the spring 14 is received on the spring mount 36 and disposed between the second shoulder 32e and the axial end face 40 of the head 34. In the example provided, the spring 14 comprises a plurality of Belleville spring washers having an inside diametrical surface that is larger in diameter than the exterior diameter of the spring mount 32b but smaller in diameter than the shaft portion 32c. Accordingly, the shaft 32 and the head 34 cooperate to limit movement of the spring 14 in an axial direction along the pivot axis 30. It will be appreciated that other types of springs, including wave springs or a helical coil compression spring, could be employed in lieu of the Belleville washer(s).

Optionally, a washer-like thrust member 48 can be disposed on the base 12 in abutment with the spring 14. The thrust member 48 can be configured to spread the load exerted by the spring 14 over a relatively larger surface area on an adjacent element to reduce localized stress and wear on the adjacent element. In the particular example provided, the adjacent element is a flanged bushing 50a. The thrust member 48 can be formed of a desired material, such as steel, and if desired, can be axially captured on the spring mount 32b with the spring 14 or disposed on the shaft portion 32c adjacent to the spring 14.

Returning to FIGS. 2, 3 and 4, the first arm assembly 16 can include a first arm 54, and a first tensioner wheel 56. The first arm 54 can define a first pivot hub 60, and a first wheel hub 62. The first pivot hub 60 can define a pivot aperture 64, a spring aperture 66, a first seal surface 68, and a second seal surface 70. The first pivot hub 60 can also optionally define a torsion spring guide 72 (FIG. 4), and a torsion spring abutment 74. The pivot aperture 64 is sized to receive the shaft 32 therethrough such that the first pivot hub 60 pivots relative to the base 12 about the pivot axis 30. If desired, a bushing or bearing can be disposed between the exterior surface of the shaft 32 and the inside diametrical surface of the pivot aperture 64. In the example provided, two flanged bushings 50a and 50b are employed to support the first arm 54 for pivoting motion relative to the shaft 32 about the pivot axis 30, as well as to transmit axial loads through the first arm 54. Each of the flanged bushings 50a and 50b has a tubular portion 75, which is received in the pivot aperture 64, and a flange member 76 that is disposed against an axial surface of the first pivot hub 60. In the example provided, the spring aperture 66, which is formed as a counterbore in an axial end of the first pivot hub 60 and is sized to receive at least a portion of the head 34, the spring 14, and the thrust member 48 therein, has an axial end that defines a thrust surface 80 against which the flange member 76 of the flange bushing 50a is disposed. Also in the example provided, an axial end of the first pivot hub 60 that is opposite the head 34 defines another thrust surface 82 against which the flange member 76 of flanged bushing 50b is disposed. It will be appreciated that the flanged bushings 50a and 50b could be configured to have identical tribological properties, or that the tribological properties of the flanged bushing 50a could be different from those of the flanged bushing 50b.

The first seal surface 68 can be formed on an axial end of a circumferentially extending shoulder 88 and may be disposed about the circumference of the torsion spring guide 72. The second seal surface 70 can be formed concentric with the counterbore that forms the spring aperture 66. In the example provided, the second seal surface 70 and the counterbore that forms the spring aperture 66 are sized the same, and optionally, the second seal surface 70 can be formed with a finer surface finish than the remainder of the diametrical surface of the counterbore that forms the spring aperture 66. It will be appreciated, however, that the second seal surface 70 can be formed to a diameter that is larger than that of the counterbore that forms the spring aperture 66.

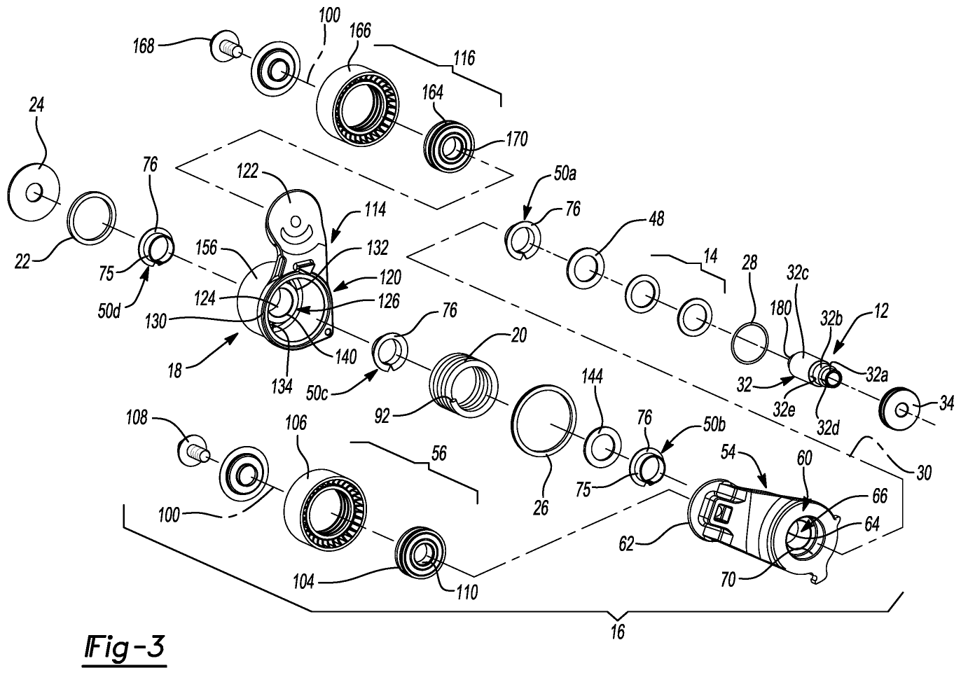

With specific reference to FIG. 4, the torsion spring guide 72 is configured to support the torsion spring 20 as the torsion spring 20 biases the first arm 54 about the pivot axis 30 relative to another component. As such, the configuration of the torsion spring guide 72 will vary depending on the configuration of the torsion spring 20. In the example provided, the torsion spring 20 is a helical coil compression spring, which has a plurality of helical coils 90 that are disposed between a first end 92 (FIG. 3) and a second, opposite end 94 (FIG. 2) of the torsion spring 20, and the torsion spring guide 72 is a helical ramp that is configured to support at least a portion of one of the helical coils 90 that terminates at the first end 92 (FIG. 3). The helical ramp can optionally be contoured so as to have a configuration that mates to or cradles the wire that forms the helical coil compression spring. Additionally or alternatively, the torsion spring guide 72 could have a lip member 96 that is configured to extend about a portion of the helical coil compression spring that can help to control the transmission of force or torque through the wire that forms the helical coil compression spring and/or helps to maintain the torsion spring 20 centered about the pivot axis 30.

Returning to FIGS. 2 through 4, the torsion spring abutment 74 is configured to transmit force or torque between the torsion spring 20 and the first arm 54. Accordingly, the configuration of the torsion spring abutment 74 is tailored to the particular type of torsion spring that is employed. In the example provided, the torsion spring abutment 74 is a planar face formed perpendicular to the helix of the torsion spring guide 72 and is configured to abut the planar, axial first end 92 of the wire that forms the torsion spring 20.

With reference to FIG. 2, the first wheel hub 62 can define a first tensioner wheel axis 100 that can be parallel to but spaced apart from the pivot axis 30.

The first tensioner wheel 56 can be mounted to the first wheel hub 62 for rotation about the first tensioner wheel axis 100. In the example provided, the first tensioner wheel 56 comprises a ball bearing 104 that is mounted to a cylindrically-shaped roller 106 and a threaded fastener 108 is threaded into the first wheel hub 62 to exert a clamping force on the inner bearing race of the ball bearing 110 to fixedly and non-rotatably couple the inner bearing race of the ball bearing 104 to the first arm 54. It will be appreciated, however, that the first tensioner wheel 56 could be formed somewhat differently, and/or could be mounted to the first wheel hub 62 differently, and/or could be configured as a pulley for engaging a desired toothed profile (e.g., with teeth, or with a V or poly-V configuration) or with a sprocket for engaging a chain.

If included, the second arm assembly 18 can have a second arm 114 and a second tensioner wheel 116. The second arm 114 can define a second pivot hub 120 and a second wheel hub 122. The second pivot hub 120 can define a pivot aperture 124, a spring aperture 126, a first seal surface 128 and a second seal surface 130. The second pivot hub 120 can also optionally define a torsion spring guide 132 and a torsion spring abutment 134 (FIG. 3). The pivot aperture 124 is sized to receive the shaft 32 therethrough such that the second pivot hub 120 is pivotable relative to the base 12 about the pivot axis 30. If desired, a bushing or bearing can be disposed between the exterior surface of the shaft 32 and the inside diametrical surface of the pivot aperture 124. In the example provided, two flanged bushings 50c and 50d, which are identical to the flanged bushings 50a and 50b, are employed to support the second arm 114 for pivoting motion relative to the shaft 32 about the pivot axis 30, as well as to transmit axial loads through the second arm 114. The tubular portion 75 of each of the flanged bushings 50c and 50d is received in the pivot aperture 124, and the flange member 76 of each of the flanged bushings 50c and 50d is disposed against associated thrust surfaces 140 and 142 formed on a respective axial end of the second pivot hub 120. It will be appreciated that the flanged bushings 50c and 50d could be configured to have identical tribological properties, or that the tribological properties of the flanged bushing 50c could be different from those of the flanged bushing 50d. It will also be appreciated that the tribological properties of the flanged bushing 50c and/or the tribological properties of the flanged bushing 50d may be identical to or different from those of the flanged bushing 50a and/or the flanged bushing 50b. If desired, a thrust member 144, similar to the thrust member 48 between the spring 14 and the flange member 76 of the flanged bushing 50a, can be disposed on the shaft 32 between the flange members 76 of the flanged bushings 50b and 50c. The spring aperture 126 can be formed as a recess in an axial end of the second pivot hub 120 and is sized to receive the spring 14 and, if included, the thrust member 144 therein.

The first seal surface 128 can be formed as the bottom wall of a circumferentially extending groove 150 that is formed in a second, opposite axial end of the second pivot hub 120. The second seal surface 130 can be formed as the shoulder of a counterbore that is formed into a first axial end of the second pivot hub 120 concentric with the spring aperture 126.

In the example provided, the torsion spring 20 is configured to bias the first and second arms 54 and 114 apart from one another about the pivot axis 30. The torsion spring guide 132 is configured to support the torsion spring 20 as the torsion spring 20 biases the second arm 114 about the pivot axis 30 relative to the first arm 54 (i.e., the torsion spring 20 biases the first and second arms 54 and 114 toward one another). As such, the configuration of the torsion spring guide 132 will vary depending on the configuration of the torsion spring 20. In the example provided, the torsion spring guide 132 is a helical ramp that is configured to support at least a portion of one of the helical coils 90 that terminates at the second end 94. The helical ramp can optionally be contoured so as to have a configuration that mates to or cradles the wire that forms the helical coil compression spring. Additionally or alternatively, the torsion spring guide 132 could have a lip member 154, which could be a projection formed on an outer circumferential wall 156 of the second pivot hub 120, that is configured to extend about a portion of the helical coil compression spring that can help to control the transmission of force or torque through the wire that forms the helical coil compression spring and/or helps to maintain the torsion spring 20 centered about the pivot axis 30.

The torsion spring abutment 134 is configured to transmit force or torque between the torsion spring 20 and the second arm 114. Accordingly, the configuration of the torsion spring abutment 74 is tailored to the particular type of torsion spring that is employed. In the example provided, the torsion spring abutment 134 is a planar face formed perpendicular to the helix of the torsion spring guide 132 and is configured to abut the planar, axial second end 94 of the wire that forms the torsion spring 20.

The second wheel hub 122 can define a second tensioner wheel axis 160 that can be parallel to but spaced apart from the pivot axis 30. The second tensioner wheel 116 can be mounted to the second wheel hub 122 for rotation about the second tensioner wheel axis 160. In the example provided, the second tensioner wheel 116 comprises a ball bearing 164 that is mounted to a cylindrically-shaped roller 166 and a threaded fastener 168 is threaded into the second wheel hub 122 to exert a clamping force on the inner bearing race of the ball bearing 164 to fixedly and non-rotatably couple the inner bearing race 170 of the ball bearing 164 to the second arm 114. It will be appreciated, however, that the second tensioner wheel 116 could be formed somewhat differently, and/or could be mounted to the second wheel hub 122 differently, and/or could be configured as a pulley for engaging a desired toothed profile (e.g., with teeth, or with a V or poly-V configuration) or with a sprocket for engaging a chain.

The torsion spring 20 can be received between the first and second pivot hubs 60 and 120 and can be disposed on the torsion spring guides 70 and 132, respectively, with the first and second ends 92 and 94 in abutment with the torsion spring abutments 74 and 134, respectively. In the example provided, the helical coil compression spring causes the torsion spring 20 to operate as an “opening spring” in that that helical coils 90 of the helical coil compression spring unwind to cause the diameter of the helical coil compression spring to increase as the magnitude of the torque that is stored in the helical coil compression spring increases. It will be appreciated, however, that the helical coil compression spring could be formed as a “closing spring”, in which case the spring would have tangs disposed between a plurality of helical coils and the torsion spring abutments 74 and 134 would be configured to engage a respective one of the tangs.

With reference to FIG. 4, the optional closure member 22 can be coupled to the base 12 to retain the several components to the base 12. In the example provided, the base 12 further comprises a coupling segment 180 that is disposed on an end of the shaft 32 opposite the spring mount 32b. The closure member 22 can be installed to and retained on the coupling segment 180 in any desired manner. For example, the closure member 22 can be an annular washer-like structure that can be received on the coupling segment 180 and driven against the shaft 32, which can be larger in diameter than the coupling segment 180, and can be secured in place, for example by peening over the portion of the coupling segment 180 that extends through the closure member 22. In the example provided, however, the closure member 22 is disposed axially along the pivot axis 30 relative to the coupling segment 180 so as to compress the spring 14, and optionally the torsion spring 20 and/or one or more of the first, second and third seals 24, 26 and 28, apply a preload force of a desired magnitude to the various thrust surfaces of the first and second arms 54 and 114. Assuming that there is appropriate control of the tribological properties of the various components of the tensioner 10 (e.g., surface finish, static and dynamic coefficients of friction), the axial preloading of force to the tensioner 10 can help to control the damping of relative movement between the first arm 54 and the base 12, and/or between the second arm 114 and the base 12, and/or between the first and second arms 54 and 114 in a desired manner, which may be important when loads on the tensioner 10 change or reverse during operation of the drive into which the tensioner 10 is integrated. Once the closure member 22 is located along the pivot axis 30 in a desired location, it may be fixedly coupled to the coupling segment 180 in any desired manner, such as via a weld, staking, or peening. In the example provided, the closure member 22 is fitted to the coupling segment 180 with an interference fit, such as a press-fit, that is sufficiently strong so as to resist relative axial and rotational movement between the coupling segment 180 and the closure member 22. Optionally, the exterior of the coupling segment 180 and the interior of the closure member 22 can be configured in a mating but non-round manner (e.g., square, hexagonal, octagonal) that aids in preventing relative rotation between the closure member 22 and the coupling segment 180.

The first seal 24 can be disposed between the closure member 22 and the second arm 114, the second seal 26 can be disposed between the first and second arms 54 and 114, and the third seal 28 can be received between the base 12 and the first arm 54. The first, second and third seals 24, 26 and 28 can be configured to inhibit moisture, lubricant, dirt and debris into an area of the tensioner 10 that would promote wear or corrosion of various components of the tensioner 10 and/or would affect the damping of relative movement between the first arm 54 and the base 12, and/or between the second arm 114 and the base 12, and/or between the first and second arms 54 and 114.

The first and second seals 24 and 26 can be any type of seal that is configured to be in a joint where there is relative rotational movement between two components. In the example provided, the first and second seals 24 and 26 are lip seals having a pair of circumferentially extending lips 184. The first seal 24 is received into the groove 150 in the second pivot hub 120 and the lips 184 of the first seal 24 are sealingly engaged to the first seal surface 128 on the second arm 114 and a seal surface 190 formed on the closure member 22. The second seal 26 can be received about the shoulder on the first pivot hub 60 and the lips 184 of the second seal 26 are sealingly engaged to the first seal surface 68 formed on the shoulder of the first pivot hub 60 and the second seal surface 70 formed on the shoulder of the counterbore in the second pivot hub 120.

The third seal 28 can be any type of seal that is disposed radially between a pair of components that rotate relative to one another. In the example provided, the third seal 28 is an O-ring that is received into the seal groove 44 in the head 34 and is sealingly engaged to a radially inner surface of the seal groove 44 in the head 34 and to the second seal surface 70 that is formed on the first pivot hub 60.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tensioner comprising:
a base defining a pivot axis and having a shaft, and a head, the shaft being fixedly coupled to the head and having a spring mount that is disposed axially adjacent to the head, wherein the spring mount has an exterior surface that is smaller in diameter than an exterior surface of a portion of the shaft that is adjacent to the spring mount;
a spring received on the spring mount, wherein the shaft and the head cooperate to limit movement of the spring in an axial direction along the pivot axis;
a first arm disposed on the shaft for pivoting motion about the pivot axis; and
a first tensioner wheel coupled to the first arm for rotation about a first tensioner wheel axis that is parallel to but spaced apart from the pivot axis;
wherein the spring exerts an axial force that is directed along the pivot axis to urge the first arm away from the head.

2. The tensioner of claim 1, wherein the spring comprises one or more Belleville spring washers.

3. The tensioner of claim 1, further comprising a seal that is received into a seal groove that is formed about a circumference of the head, the seal being sealingly engaged to the head.

4. The tensioner of claim 3, wherein the seal also sealingly engages the first arm.

5. The tensioner of claim 1, wherein the shaft has a coupling segment that is disposed on an end of the shaft opposite the spring mount, and wherein the tensioner further comprises a closure member that is received onto the coupling segment.

6. The tensioner of claim 5, wherein the closure member is slidably received on the coupling segment and does not engage a hard stop formed on a component of the tensioner that would limit movement of the closure member along the pivot axis in a direction toward the spring.

7. The tensioner of claim 6, wherein the closure member engages a cylindrical surface of the coupling segment with an interference fit.

8. The tensioner of claim 7, wherein the interference fit is a press fit.

9. The tensioner of claim 1, further comprising a second arm and a second tensioner wheel, the second arm being disposed on the shaft for pivoting motion about the pivot axis, the second tensioner wheel being coupled to the second arm for rotation about a second tensioner wheel axis that is parallel to but spaced apart from the pivot axis.

10. The tensioner of claim 9, wherein the first arm is disposed along the pivot axis between the spring and the second arm.

11. The tensioner of claim 9, further comprising a torsion spring disposed between the first and second arms, the torsion spring biasing the first and second arms towards one another about the pivot axis.

12. The tensioner of claim 11, further comprising a closure member, a first seal and a second seal, the closure member being coupled to the base on a side of the shaft that is opposite the spring mount, the first seal being sealingly engaged to the closure member and the first arm, the second seal being sealingly engaged to the first and second arms.

13. The tensioner of claim 11, wherein the torsion spring has a plurality of helical coils that are disposed between a first spring end and a second spring end, wherein the first spring end abuts the first arm and wherein the second spring end abuts the second arm.

14. The tensioner of claim 1, further comprising a torsion spring coupled to the first arm, the torsion spring being configured to bias the first arm in a predetermined direction about the pivot axis.

15. The tensioner of claim 14, wherein the torsion spring has a plurality of helical coils that are disposed between a first spring end and a second spring end and wherein the first spring end abuts the first arm.

16. The tensioner of claim 1, wherein the shaft is press-fit to the head.

17. A method for assembling a tensioner, the method comprising:
providing a shaft, and a head, the shaft having a head mount and a spring mount;
positioning a spring over the shaft and onto the spring mount;
assembling the shaft to the head such that the head and a shoulder formed on the shaft limit movement of the spring along a pivot axis in a direction away from the head;
assembling a first arm onto the shaft, the first arm being pivotable about the pivot axis relative to the shaft;
applying an axial preload to the spring; and
coupling a closure member to base to maintain the axial preload on the spring.

18. The method of claim 17, wherein prior to applying an axial preload to the spring the method comprises assembling a second arm to the shaft, wherein the first arm is disposed along the pivot axis between the spring and the second arm.
